(19) United States
(12) Patent Application Publication
(10) Pub. No.: US 2012/0261899 A1
(43) Pub. Date: Oct. 18, 2012

(54) THREE-POINT HITCH CONVERTER

(76) Inventor: Jay L. Ockunzzi, Solon, OH (US)

(21) Appl. No.: 13/448,330

(22) Filed: Apr. 16, 2012

Related U.S. Application Data
(60) Provisional application No. 61/476,213, filed on Apr. 15, 2011.

(51) Int. Cl. B60D 1/07

(52) U.S. Cl. 280/416.1

(57) ABSTRACT

A three-point hitch converter allows three-point tractor implements to hook to a standard trailer hitch of a vehicle. The hitch converter can attach to a standard trailer hitch receiver the same way as a conventional ball hitch. The hitch converter includes a frame having points to attach tractor-type three-point lift links. The hitch converter also includes mount points for a snowplow-type attachment, a winch, or one or more hydraulic cylinders for lifting the implement.

### CROSS-REFERENCE TO RELATED APPLICATIONS

This application claims the benefit of priority of U.S. provisional patent application No. 61/476,213, filed Apr. 15, 2011, the contents of which are herein incorporated by reference.

### BACKGROUND OF THE INVENTION

The present invention relates to equipment hitching devices and, more particularly, to a three-point hitch converter for standard trailer hitches that allows tractor implements to hook to a vehicle.

Tractor implements typically are designed to attach to the tractor's three-point hitch. This is a conventional design used by many, if not all makes and models of tractors. These implements, however, cannot be attached to or used with a standard vehicle trailer hitch.

As can be seen, there is a need for a device to permit three-point implements to be attached to standard vehicle trailer hitches.

### SUMMARY OF THE INVENTION

In one aspect of the present invention, a hitch converter comprises a shaft adapted to be retained by a vehicle hitch receiver; a frame assembly fixed to the shaft; lower three-point lift links provides on lower opposite corners of the frame assembly; a lift bar assembly pivotably attached to the frame assembly; and an upper three-point lift link provided on a mid-section of the lift bar assembly.

In another aspect of the present invention, a hitch converter comprises a shaft adapted to be retained by a vehicle hitch receiver; a frame assembly fixed to the shaft; lower three-point lift links provides on lower opposite corners of the frame assembly; a lift bar assembly pivotably attached to the frame assembly; an upper three-point lift link provided on a mid-section of the lift bar assembly; lift arms pivotably attached to and extending from the lower three-point lift links; vertical lift links connected from the lift arms to each end of lift bar assembly; hydraulic lift cylinders connected from each side of the frame assembly to each end of the lift bar assembly; and an upper link extending from the upper three-point lift link.

These and other features, aspects and advantages of the present invention will become better understood with reference to the following drawings, description and claims.

### BRIEF DESCRIPTION OF THE DRAWINGS

FIG. 1 is a perspective view of a three-point hitch converter according to an exemplary embodiment of the present invention, in use, on a vehicle;

FIG. 2 is a perspective view of the three-point hitch converter of FIG. 1;

FIG. 3 is an exploded perspective view of the three-point hitch converter of FIG. 1; and

FIG. 4 is a side view of the three-point hitch converter of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a three-point hitch converter that allows three-point tractor implements to hook to a standard trailer hitch of a vehicle. The hitch converter can attach to a standard trailer hitch receiver the same way as a conventional ball hitch. The hitch converter includes a frame having points to attach tractor-type three-point lift links. The hitch converter also includes mount points for a snowplow-type attachment, a winch, or one or more hydraulic cylinders for lifting the implement.

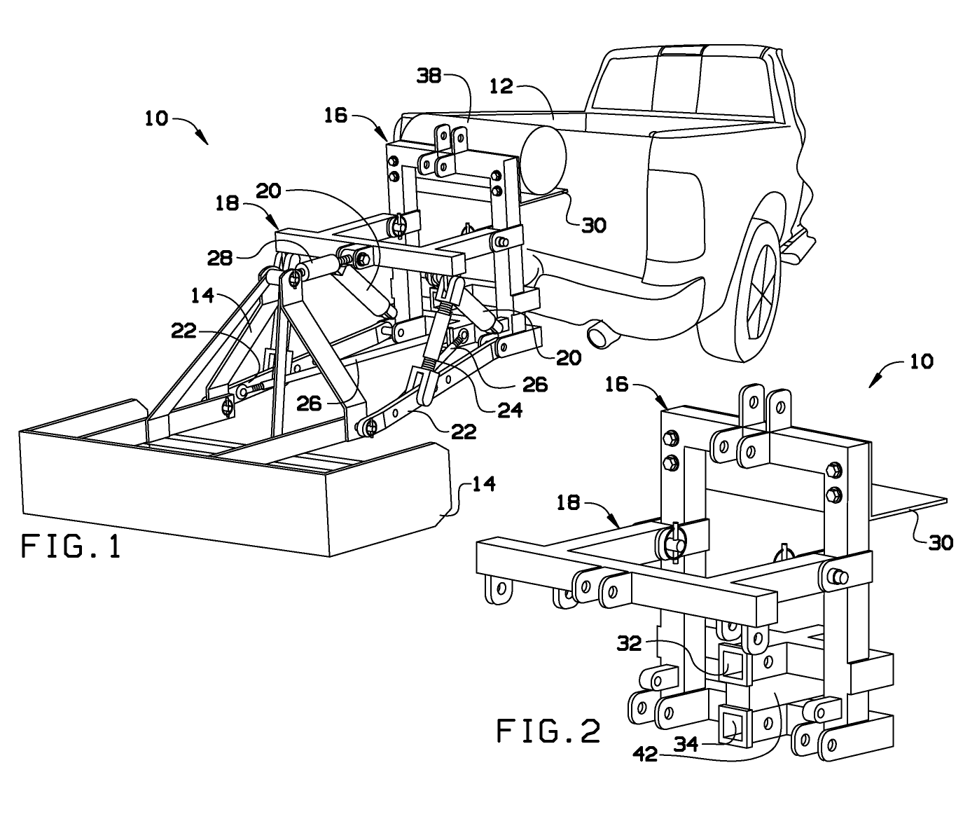

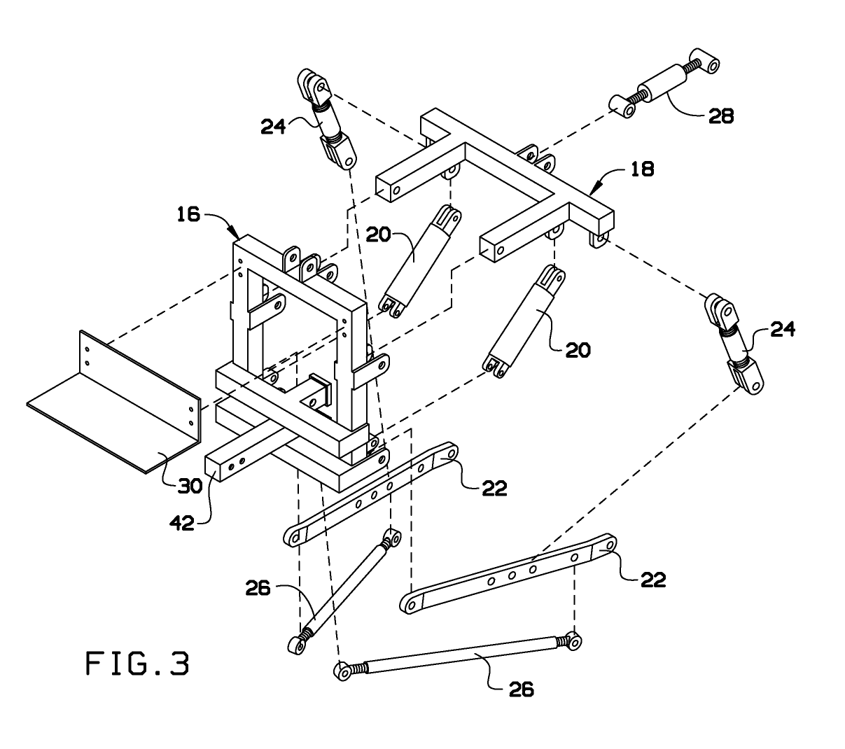

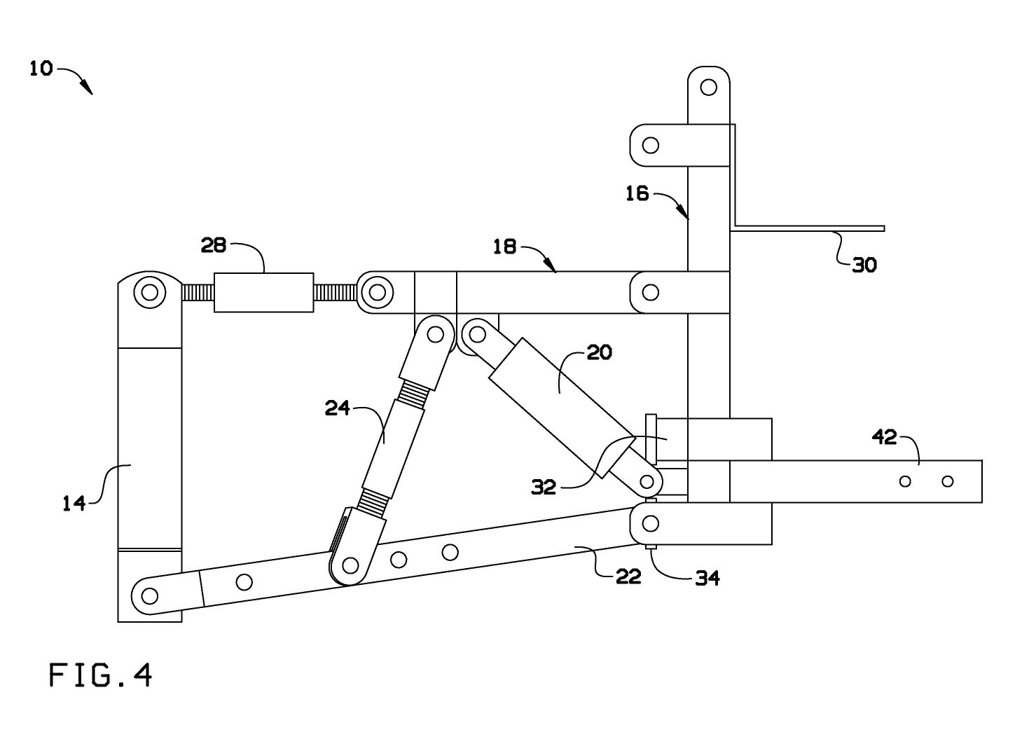

Referring now to FIGS. 1 through 4, there is shown a hitch converter 10 that may be used to attach a three-point tractor implement 14 to a vehicle 12 that has a standard hitch receiver (not shown). A solid shaft 42 may fit into the standard hitch receiver by conventional methods. For example, a pin may fit through the standard hitch receiver and through a hole in the solid shaft 42 to retain the solid shaft 42 in the standard receiver hitch. An upper hitch extension 32 and a lower hitch extension 34 may be disposed on each of the top and bottom of the solid shaft 42, at an end opposite the end of the solid shaft 42 that fits into the standard hitch receiver. The upper and lower hitch extensions 32, 34 may allow the vehicle 12 to hitch to another device that connects to a standard hitch receiver, such as a trailer, without having to remove the hitch converter 10.

A frame assembly 16 may be affixed to the solid shaft 42. The frame assembly 16 may form a rectangular or upside-down U-shaped frame structure attached to the solid shaft 42. The frame assembly 16 may define a plane generally perpendicular to the axis of the solid shaft 42. Left and right lower three-point link points 46 may be disposed at or near lower corners of the frame assembly 16. A lift bar assembly 18 may extend from and be pivotably attached to the frame assembly 14, connecting to each side of the frame assembly 16, above the left and right lower three-point link points 46.

A hydraulic pump/winch mount plate 10 may attach to the frame assembly 16 to provide a means to lift the implement 14 when it is attached to the hitch converter 10. In some embodiments, a hydraulic pump 38 may power hydraulic cylinders 20 to extend or retract, causing the lift bar assembly to raise and lower.

Vertical lift links 24 may be disposed on each end of the lift bar assembly 18. The vertical lift links 24 may connect to lift arms that connect from the lower three-point link lifts 46 to lower three-point attachment points of the implement 14. When the hydraulic cylinders 20 extend, the lift bar assembly 18 raises, lifting the vertical lift links, and, in turn lifting the lift arms 22 and the implement 14.

A upper link may extend from an upper three-point lift link 44, disposed on a mid-section of the lift bar assembly 18, to an upper three-point attachment point of the implement 14.

Lower side links 26 may extend from a pivoting connection at the frame assembly 16 to a pivoting connection at a distal end of the lift arms 22. The lower side links 26 may help stabilize the implement 14 and minimize side-to-side swaying of the implement 14.

The vertical lift link 24 and the upper link 28 may be adjustable in length, as is known in the art to adjust the position of the implement 14. While FIG. 1 shows a box blade, other implements may be carried by the hitch converter 10 of the present invention.

The hitch converter 10 may be used to carry implements to a remote site to change them out on a tractor, for example. In some embodiments, the hitch converter 10 may be used to allow the vehicle 12 to actually use the implement itself.

Controls (not shown) may be provided to control the hydraulic pump 38 (or winch, for example). The controls may be powered by a 12 volt DC current from a battery of the vehicle 12.

It should be understood, of course, that the foregoing relates to exemplary embodiments of the invention and that modifications may be made without departing from the spirit and scope of the invention as set forth in the following claims.

What is claimed is:

1. A hitch converter comprising:
a shaft adapted to be retained by a vehicle hitch receiver;
a frame assembly fixed to the shaft;
lower three-point lift links provides on lower opposite corners of the frame assembly;
a lift bar assembly pivotably attached to the frame assembly; and
an upper three-point lift link provided on a mid-section of the lift bar assembly.

2. The hitch converter of claim 1, further comprising a mount plate attached to the frame assembly.

3. The hitch converter of claim 1, further comprising at least one hitch extension providing a hitch receiver attached to the frame assembly.

4. The hitch converter of claim 3, further comprising an upper hitch extension and a lower hitch extension.

5. The hitch converter of claim 1, further comprising lift arms pivotably attached to and extending from the lower three-point lift links.

6. The hitch converter of claim 5, further comprising vertical lift links connected from the lift arms to each end of lift bar assembly.

7. The hitch converter of claim 6, further comprising hydraulic lift cylinders connected from each side of the frame assembly to each end of the lift bar assembly.

8. The hitch converter of claim 7, further comprising an upper link extending from the upper three-point lift link.

9. A hitch converter comprising:
a shaft adapted to be retained by a vehicle hitch receiver;
a frame assembly fixed to the shaft;
lower three-point lift links provides on lower opposite corners of the frame assembly;
a lift bar assembly pivotably attached to the frame assembly;
an upper three-point lift link provided on a mid-section of the lift bar assembly;
lift arms pivotably attached to and extending from the lower three-point lift links;
vertical lift links connected from the lift arms to each end of lift bar assembly;
hydraulic lift cylinders connected from each side of the frame assembly to each end of the lift bar assembly; and
an upper link extending from the upper three-point lift link.

10. The hitch converter of claim 9, further comprising:
a mount plate attached to the frame assembly; and
at least one hitch extension providing a hitch receiver attached to the frame assembly.
